(19) United States
(12) Patent Application Publication
(10) Pub. No.: US 2006/0199053 A1
(43) Pub. Date: Sep. 7, 2006

(54) Fuel cell system

(76) Inventors: Jin Hong An, Yongin (KR); Ri A Ju, Yongin (KR); Jun Won Suh, Yongin (KR)

Correspondence Address: CHRISTIE, PARKER & HALE, LLP, PO BOX 7068, PASADENA, CA, 91109-7068, US

(21) Appl. No.: 11/370,443

(22) Filed: Mar. 7, 2006

(30) Foreign Application Priority Data
Mar. 7, 2005 (KR) 10-2005-18841

(51) Int. Cl. H01M 8/04; H01M 8/10

(52) U.S. Cl. 429/24; 429/34; 429/30

(57) ABSTRACT

A fuel cell system for rapidly initiating a fuel cell stack. The fuel cell system includes a fuel cell stack including at least one unit fuel cell for generating electricity through an electro-chemical reaction of an oxidant and a fuel containing hydrogen, a fuel-supplying unit for supplying the fuel and the oxidant to the fuel cell stack, a sensor for detecting a temperature of the fuel cell stack, an initiation load having a predetermined resistance, and a switching part for electrically connecting the initiation load to an output terminal of the fuel cell stack.

### CROSS-REFERENCE TO RELATED APPLICATION

This application claims priority to and the benefit of Korean Patent Application No. 10-2005-0018841, filed on Mar. 7, 2005 with the Korean Intellectual Property Office, the entire content of which is incorporated herein by reference.

### BACKGROUND

1. Field of the Invention

The present invention relates to an initial driving system of a fuel cell, and more particularly, to a fuel cell system capable of rapidly warming up a stack by using an inner initiation load.

2. Discussion of Related Art

A fuel cell is a power generation system for directly converting chemically reactive energy of oxygen and hydrogen contained in hydrocarbon material such as methanol, ethanol, and natural gas into electric energy.

Fuel cells can be categorized into phosphoric acid fuel cells, molten carbonate fuel cells, solid oxide fuel cells, polymer electrolyte membrane fuel cells, and alkaline fuel cells, in accordance with the kind of electrolyte used. Each fuel cell operates on about the same principle, but they vary in the kind of fuel, operation temperature, catalyst, and electrolyte used.

A polymer electrolyte membrane fuel cell (PEMFC) has an output characteristic higher than the other types of fuel cells, operates at low temperature, and has high starting and response characteristics. In addition, the PEMFC is widely used as a dispersive power source such as a static power station for a house or a public building, as well as a transportable power source for a portable electronic apparatus or a vehicle.

The above-described PEMFC includes a stack, a reformer, a fuel tank, and a fuel pump. In the PEMFC, the fuel in the fuel tank is supplied to the reformer by an operation of the fuel pump. The reformer reforms the fuel to generate hydrogen gas. The stack electrochemically reacts the hydrogen gas and oxygen with each other to generate electric energy.

A direct methanol fuel cell (DMFC) is similar to the PEMFC, but the DMFC can directly supply liquid methanol fuel to its stack. Since the DMFC does not need to use the reformer that is in the PEMFC, it can be small in size.

A fuel cell stack includes a structure having several unit fuel cells that are stacked adjacent to one another. Each of the unit fuel cells includes a membrane electrode assembly (MEA) and a separator. Here, the MEA has a structure in which an anode electrode (referred to as an anode) and a cathode electrode (referred to as a cathode) are attached to each other with a polymer electrolyte membrane interposed therebetween.

FIG. 1 schematically illustrates an operation of a common fuel cell 10 including a polymer electrolyte membrane 20. Referring to FIG. 1, an MEA 20 of the fuel cell 10 includes the polymer electrolyte membrane 12, an anode catalyst layer 14, and a cathode catalyst layer 16. When fuel containing the hydrogen gas or hydrogen is supplied to the anode catalyst layer 14 in the fuel cell 10, an electrochemical oxidation process occurs in the anode catalyst layer 14 so that ionization and oxidation are performed to generate hydrogen ions H⁺ and electrons e⁻. The ionized hydrogen ions are transmitted from the anode catalyst layer 14 to the cathode catalyst layer 16 through the polymer electrolyte membrane 12. The electrons are transmitted from the anode catalyst layer 14 to the cathode catalyst layer 16 through an external wiring line 18. The hydrogen ions transmitted to the cathode catalyst layer 16 perform electrochemical reduction on the oxygen supplied to the cathode catalyst layer 16 to generate heat and water. Electrical energy is generated by the transmission of the electrons.

The electrochemical reactions in the PEMFC and the DMFC can be represented as follows in EQUATIONS 1 and 2, respectively.
ANODE ELECTRODE: H₂→2H⁺+2e⁻
CATHODE ELECTRODE: ½O₂+2H⁺+2e⁻→H₂O [EQUATION 1]
ANODE ELECTRODE: CH₃OH+H₂O→CO₂+6H++6e−
CATHODE ELECTRODE: 3/2O₂+6H⁺+6e⁻→3H₂O [EQUATION 2]

A fuel cell exhibits optimal performance at a proper temperature. Thus, in order to properly use the fuel cell, since a fuel cell stack is not warmed up yet when the fuel cell is initiated, a user must wait for the fuel cell stack to be heated to a predetermined temperature. If an electric power of the fuel cell is consumed (or used) before the temperature of the fuel cell stack reaches the predetermined temperature, that is, before the stack is stabilized, the performance of the fuel cell stack is deteriorated, and/or the electricity is not generated.

Additionally, a fuel cell should be able to be rapidly initiated. In other words, when the fuel cell is used as an electric power source for a portable electronic device or a vehicle, the fuel cell is required to be rapidly initiated even in low or cold temperature circumstance for the purpose of prompt use and convenience.

### SUMMARY OF THE INVENTION

Accordingly, it is an aspect of the present invention to provide a fuel cell system capable of rapidly initiating a fuel cell stack even in a low or cold temperature circumstance by coupling an initiation load with an output terminal of the fuel cell stack when initiating the fuel cell system.

It is another aspect of the present invention to provide a fuel cell system in which an electricity supplying time is controlled by measuring the temperature of a fuel cell stack that is rapidly warmed up by an inner initiation load.

It is still another aspect of the present invention to provide a fuel cell system in which an electricity supplying time is controlled by setting a preheat time of a fuel cell stack by an inner initiation load with a timer.

An embodiment of the present invention provides a fuel cell system having a fuel cell stack including at least one unit fuel cell for generating electricity through an electro-chemical reaction of an oxidant and a fuel containing hydrogen, a fuel-supplying unit for supplying the fuel and the oxidant to the fuel cell stack, a sensor for detecting a temperature of the fuel cell stack, an initiation load having a predetermined resistance, and a switching part for electrically connecting the initiation load to an output terminal of the fuel cell stack.

In one embodiment, the initiation load includes a load of a peripheral device included in the fuel-supplying unit, and/or the initiation load includes a rod resistor for emitting an electric power applied through the output terminal of the fuel cell stack as heat.

In one embodiment, the fuel cell system further includes a controller for controlling a supply of the fuel and the oxidant depending on a predetermined driving signal and for controlling the switching part such that the initiation load is connected to the fuel cell stack.

In one embodiment, the controller electrically separates the initiation load from the fuel cell stack through the switching part when the temperature detected by the sensor is within a predetermined range.

In one embodiment, the controller electrically separates an external load from the fuel cell stack depending on the driving signal and electrically connects the external load to the fuel cell stack when the temperature detected by the sensor is within the predetermined range.

In one embodiment, the switching part includes a first switching part connected between the fuel cell stack and the initiation load and a second switching part connected between the fuel cell stack and the external load.

In one embodiment, the switching part responds to a stop signal of the fuel cell system to reconnect the initiation load with the fuel cell stack.

Another embodiment of the present invention provides a fuel cell system having a fuel cell stack including at least one unit fuel cell for generating electricity through an electro-chemical reaction of an oxidant and a fuel containing hydrogen, a fuel-supplying unit for supplying the fuel and the oxidant to the fuel cell stack, an initiation load having a predetermined resistance, a switching part for connecting the initiation load to an output terminal of the fuel cell stack, and a timer connected to a control terminal of the switching part to control the switching part using an ON-setting time.

In one embodiment, the fuel cell system further includes a controller for controlling the supply of the fuel and the oxidant depending on a driving signal for driving the fuel cell stack and for turning on the timer.

In one embodiment, the fuel cell system further includes a sensor for detecting a temperature of the fuel cell stack, wherein the controller controls the timer to electrically separate the initiation load from the fuel cell stack through the switching part when the temperature inputted from the sensor is within a predetermined range.

In one embodiment, the controller extends the ON-setting time of the timer as long as the temperature inputted from the sensor is not within the predetermined range.

In one embodiment, the switching part is turned off such that the initiation load is electrically separated from the fuel cell stack after the ON-setting time of the timer has lapsed.

In one embodiment, the switching part responds to a stop signal of the fuel cell system to reconnect the initiation load to the fuel cell stack.

In one embodiment, the fuel cell system further includes a battery for supplying an electric power to the controller, a pump or a valve in the fuel-supplying unit, a heating device for heating the fuel cell stack according to a driving signal, and/or a power converter for converting and transmitting an output voltage of the fuel cell stack to the external load.

In one embodiment, the fuel-supplying unit includes a heating device for heating at least one of the fuel or the oxidant according to a driving signal.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a sectional view illustrating an operation principle of a common fuel cell including a polymer electrolyte membrane;

FIG. 2 is a block diagram schematically illustrating a fuel cell system according to a first embodiment of the present invention;

FIG. 3 is a block diagram illustrating a fuel cell system according to a second embodiment of the present invention;

FIG. 4 is a flowchart illustrating a process of rapidly initiating the fuel cell stack of the fuel cell system according to the second embodiment of the present invention;

FIG. 5 is a block diagram illustrating a fuel cell system according to a third embodiment of the present invention;

FIG. 6 is a block diagram illustrating a fuel cell system according to a fourth embodiment of the present invention;

FIG. 7 is a flowchart illustrating a process of rapidly initiating the fuel cell stack of the fuel cell system according to the fourth embodiment of the present invention, and

FIG. 8 is a graph illustrating comparisons of initiations of the fuel cell stacks according to the first to fourth embodiments of the present invention with an initiation of a conventional fuel cell stack.

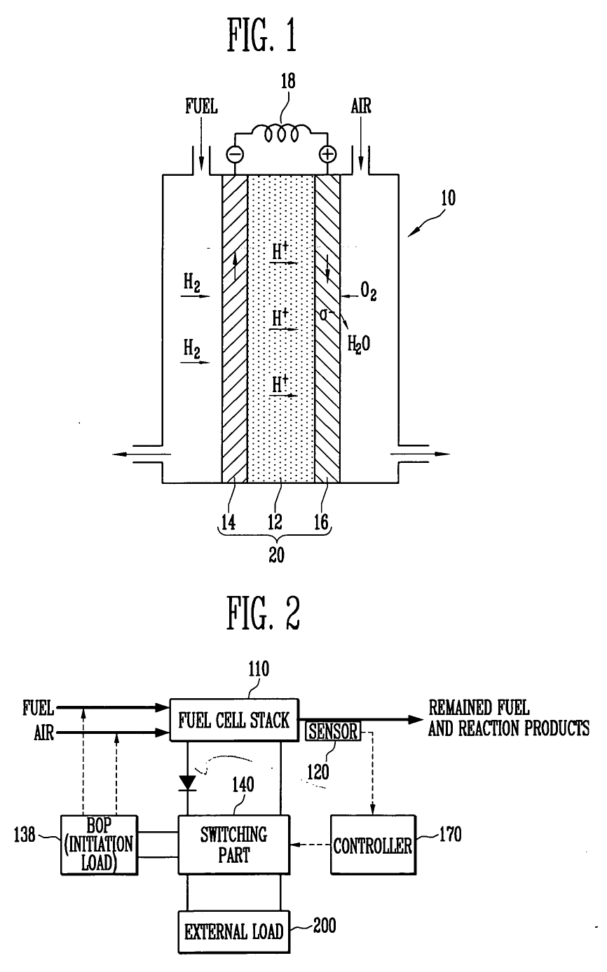

### DETAILED DESCRIPTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

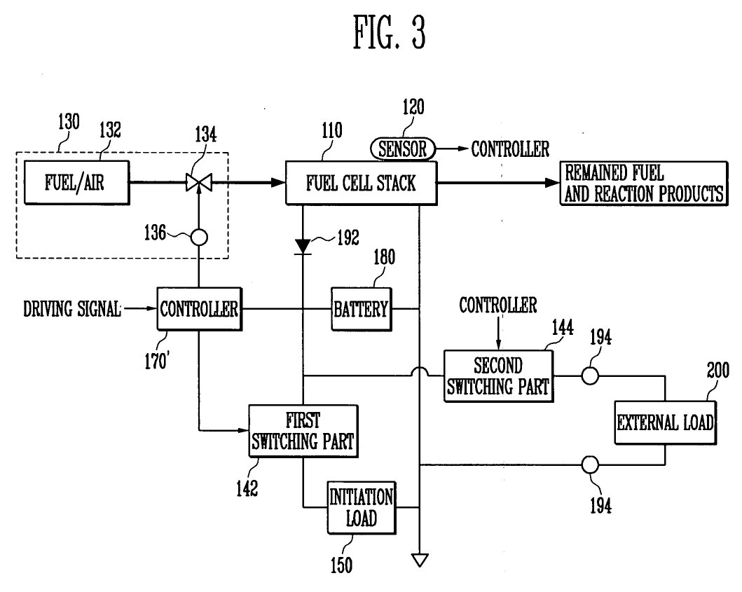

FIG. 2 is a block diagram schematically illustrating a fuel cell system according to a first embodiment of the present invention.

Referring to FIG. 2, the fuel cell system according to the first embodiment of the present invention rapidly warms up a fuel cell stack 110 by connecting an output terminal to a peripheral device (e.g., an initiation load) 138 when initiating the fuel cell system. In FIG. 2, the fuel cell system according to the first embodiment of the present invention includes the fuel cell stack 110, a sensor 120, the peripheral device 138, a switching part 140, and a controller 170.

In more detail, the fuel cell stack 110 generates electric energy through electro-chemical reaction of fuel containing hydrogen and oxidant. For example, the fuel cell stack 110 includes a membrane-electrode assembly for generating electricity through the oxidation reduction of hydrogen and oxygen, and a separator closely contacting both sides of the membrane-electrode assembly and supplying a fuel containing hydrogen and/or an oxidant, such as oxygen or air, to the membrane-electrode assembly. Moreover, the fuel cell stack 110 has a laminated structure in which a plurality of unit cells are pressed and sealed. In one embodiment, the separator may be omitted according to a structure of a certain type of the fuel cell stack 110.

Moreover, the fuel cell stack 110 supplies electric energy having a predetermined voltage difference to an external load 200 via a current collector (not shown) positioned on both sides or the outmost side of the fuel stack 110. For example, the external load 200 may be a portable electronic device such as a personal digital assistant (PDA), a portable multimedia player (PMP), and so on. Additionally, the fuel cell stack 110 discharges fuel remaining after use together with reaction products. The remaining fuel can be used as fuel for a recycling device, and the reaction products such as carbon dioxide are discharged to the atmosphere.

The sensor 120 detects temperature of the fuel cell stack 110 and transmits the detected temperature to the controller 170. The detected temperature includes an analog signal or a digital signal depending on the type of the sensor 120 used. Moreover, the sensor 120 may be attached with the outside or the inside of the fuel cell stack 110 and kept in contact or non-contact therewith. For example, the sensor 120 may be implemented by a thermistor in which a resistance is changed depending on the temperature of a material when the thermistor is embedded in or attached to the material.

The peripheral device 138 includes a device for supplying fuel or air to the fuel cell stack 110. For example, the peripheral device 138 includes an air pump, a fuel pump, a valve controller, etc.

Moreover, the peripheral device 138 serves as an initiation load in a resistor connected to the fuel cell stack 110 when initiating the fuel cell system. In other words, a conventional peripheral device is driven by a separated power source, such as a battery, a commercial power source, or the like when initiating the fuel cell system, and is not driven by the output of the fuel cell stack 110 when the fuel cell stack 110 is being initiated. However, in the present invention, by connecting the output terminal of the fuel cell stack 110 to a coil of the peripheral device 138 driven by a separated power source when initiating the fuel cell system, the fuel cell stack 110 is rapidly warmed up using the peripheral device 138 as the initiation load.

The switching part 140 separates the external load 200 from the fuel cell stack 110 and connects the output terminal of the fuel cell stack 110 to the peripheral device 138 until the fuel cell stack 110 reaches a normal operating temperature during the initiation of the fuel cell system. The switching part 140 is driven by a control signal of the controller 170.

The controller 170 receives an electric power from a battery or an external commercial power source when the fuel cell system is being initiated, and controls a fuel-supplying unit for supplying fuel and air to the fuel cell stack 110. Additionally, in order to rapidly and stably warm up the fuel cell stack 110, the controller 170 connects the peripheral device 138 to the output terminal of the fuel cell stack 110. At this time, if the external load 200 is connected to the fuel cell stack 110, the controller 170, for the stable warming-up of the fuel cell stack 110, separates the external load 200 from the fuel cell stack 110.

Moreover, the controller 170 receives a temperature measurement of the fuel cell stack 110 from the sensor 120, and separates the peripheral device 138 from the fuel cell stack 110 and connects the output terminal of the fuel cell stack 110 to the external load 200 when the detected temperature ranges within a predetermined temperature range, for example, from 50 degrees centigrade to 80 degrees centigrade.

As described above, if the peripheral device 138 serves as the initiation load when initiating the fuel cell system, it is possible to rapidly warm up the fuel cell stack 110.

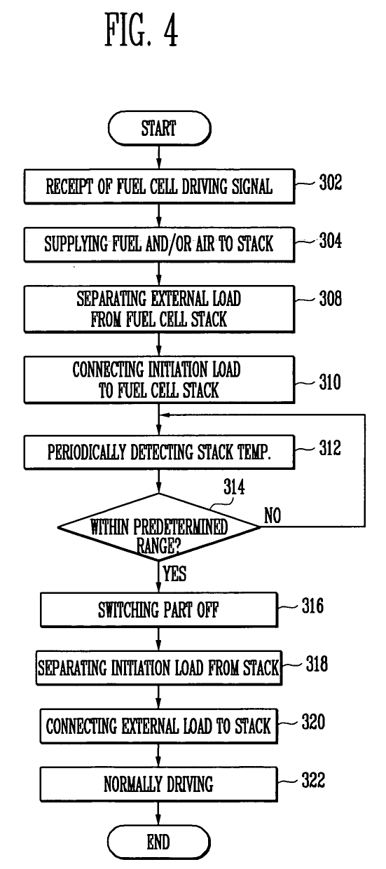

FIG. 3 is a block diagram illustrating a fuel cell system according to a second embodiment of the present invention.

Referring to FIG. 3, the fuel cell system according to this embodiment of the present invention implements a rapid initiation of the fuel cell stack 110 by rapidly warming up the fuel cell stack 110 using a separated initiation load for the initiation of the fuel cell system. To this end, the fuel cell system according to the second embodiment of the present invention includes the fuel cell stack 110, the sensor 120, a fuel-supplying unit 130, first and second switching parts 142 and 144, an initiation load 150, the controller 170′, and a battery 180. The fuel cell system is connected to the external load 200 through a predetermined connection device such as a connector 194.

Description of the fuel cell stack 110 and the sensor 120 will be omitted to avoid duplicate description of the stack 110 and the sensor 120 in the above first embodiment.

The fuel-supplying unit 130 includes a fuel tank 132 for storing fuel, a fuel pump 134 for discharging the fuel in the fuel tank 132 to the fuel cell stack 110, and a driving unit 136 for operating the fuel pump 134 according to a control signal of the controller 170′. Here, the fuel pump 134 includes a first fuel pump for supplying hydrogen or fuel containing hydrogen to the fuel cell stack 110, and a second fuel pump (e.g., an air pump) for supplying oxidant to the fuel cell stack 110. The fuel containing hydrogen can be liquefied fuel such as methanol, ethanol, natural gas, or gaseous fuel. The oxidant can be oxygen or air. Hereinafter, for the convenient description, hydrogen or the fuel containing hydrogen is referred to as a first fuel, and oxygen or air containing oxygen is referred to as a second fuel (or an oxidant).

The fuel pump 134 may be omitted when the fuel-supplying unit 130 is a passive type fuel-supplying unit 130 that does not have a pump as an optional member. Moreover, the fuel pump 134 can be replaced with a fuel valve driven by a control of the driving unit 136.

Moreover, although not depicted in the drawing, the fuel-supplying unit 130 may include a reformer for generating hydrogen gas from the fuel and reducing carbon monoxide generated as a reaction product. When the fuel cell stack of an embodiment of the present invention is a direct-methanol type fuel cell stack for directly using methanol as the first fuel, the reformer may be omitted.

The first switching part 142 is connected between the fuel cell stack 110 and the initiation load 150 for electrically connecting them to or separating them from each other. The first switching part 142 electrically connects the initiation load 150 to the fuel cell stack 110 when initiating the fuel cell. The initiation load 150 serves as a proper load to the fuel cell stack 110 such that the fuel cell stack 110 is rapidly warmed up. Moreover, the first switching part 142 electrically separates the initiation load 150 from the fuel cell stack 110 when the fuel cell stack 110 is stabilized and is to be normally driven. These ON-OFF operations of the first switching part 142 may be controlled by the controller 170′.

The second switching part 144 is connected between the fuel cell stack 110 and the external load 200 for electrically connecting them to or separating them from each other. The second switching part 144 connects the external load 200 to the fuel cell stack 110 when initiating the fuel cell. The second switching part 144 electrically connects the external load 200 to the fuel cell stack 110 when the fuel cell stack 110 is stabilized and is to be normally driven. These ON-OFF operations of the second switching part 144 may be controlled by the controller 170′.

The reason the external load 200 is electrically separated when initiating the fuel cell system is that, since resistance of the external load 200 cannot be estimated in advance, it is difficult to predict a proper warm up time of the fuel cell stack 110. This is also because, if the external load 200 having a variable resistance is connected to the fuel cell stack 110, the warm up time of the fuel cell stack 110 cannot be estimated when initiating the fuel cell stack 110; and, moreover, when the resistance of the external load 200 is increased, the increased resistance becomes a burden to the fuel cell stack 110 so that the fuel cell stack 100 cannot be normally operated, and may be stopped.

The initiation load 150 has a predetermined resistance and is connected (i.e., electrically connected) to the fuel cell stack 100 when initiating the fuel cell. The initiation load 150 can be implemented by, for example, a rod resistor for emitting electric power applied from the fuel cell stack 110 as heat. In this embodiment, the resistance of the initiation load 150 can be determined according to the structure, kind, or capacity of the fuel cell stack 110.

The controller 170′ drives the fuel cell system according to an inputted driving signal. To this end, the controller 170′ receives an electric power from the battery 180 when initiating the fuel cell system and controls the fuel cell supplying unit 130 for supplying fuel to the fuel cell stack 110. Moreover, for a rapid and stable warming-up of the fuel cell stack 110, the controller 170′ connects the initiation load 150 to the fuel cell stack 110. At this time, if the external load 200 is connected to the fuel cell stack 110, the controller 170′ separates the external load 100 from the fuel cell stack 110 for the stable warming-up of the fuel cell stack 110.

Moreover, the controller 170′ periodically receives temperature information about the fuel cell stack 110 from the sensor 120, and compares the received temperature information with a predetermined temperature to determine a normal outputting time of the fuel cell stack 110. For example, the predetermined temperature is set within a range from 50 degrees centigrade to 80 degrees centigrade in a polymer electrolyte type fuel cell stack or a direct-methanol type fuel cell stack.

Moreover, the controller 170′, when the temperature of the fuel cell stack 110 reaches the predetermined temperature range, separates the initiation load 150 from the fuel cell stack 110 and connects the external load 200 to the fuel cell stack 110. By doing so, the fuel cell system rapidly and stably reaches a normal driving state in comparison to the conventional fuel cell system.

Additionally, the controller 170′ may separate the external load 200 from the fuel cell stack 110 and connect the initiation load 150 to the fuel cell stack 110 in advance when the operation of fuel cell system is being stopped. In this case, since the fuel cell stack 110 is already in a warmed-up state (i.e., connected to the initiation load 150) when restarting the fuel cell system, the fuel cell system can be rapidly warmed up in this state.

The battery 180 supplies electric power to the controller 170′ and the fuel cell supplying unit 130 when initiating the fuel cell system. Between the fuel cell stack 110 and the battery 180, a device for preventing electric power of the battery 180 from being supplied to the fuel cell stack 110, for example, a diode 192, is connected.

The battery 180 is connected to the output terminal of the fuel cell stack 110 and charged by electric power outputted from the fuel cell stack 110 when the fuel cell stack 110 is normally driven (i.e., when the fuel cell stack 110 is stabilized). In addition, although not depicted in the FIG. 3, the battery 180 includes a battery controller (not shown) for controlling charging and discharging of the battery 180.

Moreover, the battery 180 can be used to supply electric power to the controller 170′ and the fuel-supplying unit 130 when they are electrically separated by the battery controller and/or the controller 170′ from the fuel cell stack 110.

Meanwhile, in this embodiment, the battery 180 is described as an example of a device for supplying electric power to the controller 170′ and the fuel-supplying unit 130 when initiating the fuel cell system. However, the present invention can use other suitable power-storing devices such as a capacitor as the power supplying device, or be directly connected to an external power source.

As such, the fuel cell system according to the present invention can be normally driven more rapidly and stably than the conventional fuel cell system by warming up the fuel cell stack in the state of separating the external load from fuel cell stack and connecting the initiation load having a predetermined resistance to the fuel cell stack.

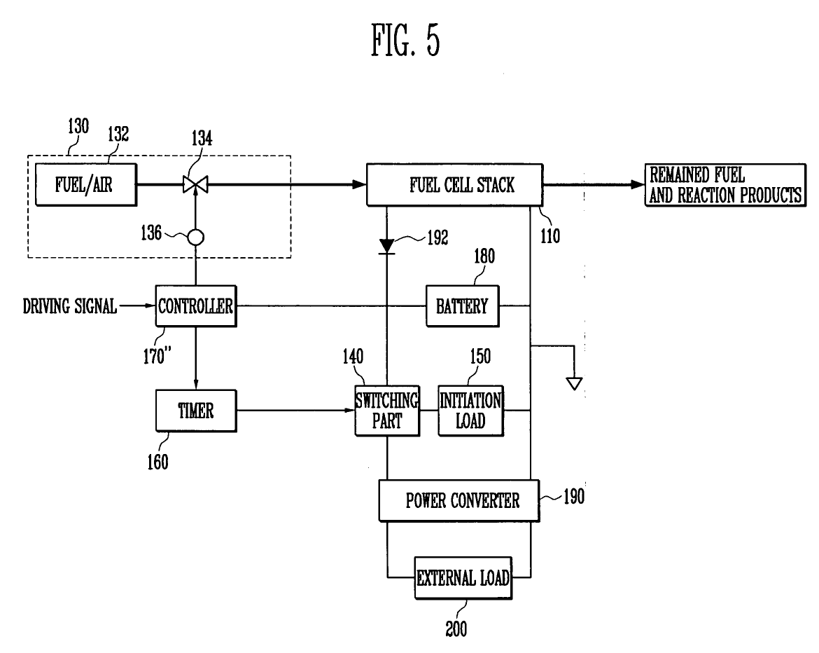

FIG. 4 is a flowchart illustrating a process of rapidly initiating the fuel cell stack of the fuel cell system according to the second embodiment of the present invention.

Referring to FIG. 4, a driving signal for driving a fuel cell system is automatically or manually inputted to the fuel cell system (302). Then, a controller receives electric power from a battery and controls the fuel cell system in a predetermined order, for example, according to a program stored in a memory (not shown).

Next, the controller controls a fuel supplying part to supply fuel to a fuel cell stack (304). For example, the controller supplies oxidant and fuel containing hydrogen, such as air and methanol, to the fuel cell stack via respective supplying path using a fuel pump and an air pump.

Then, the controller controls a second switching part (e.g., the second switching part 144) for connecting and separating the fuel cell stack to and from an external load so as to separate the external load from the fuel cell stack (308). If the external load is not connected to the fuel cell stack when initiating the fuel cell system, this step may be omitted.

Next, the controller controls a first switching part (e.g., the first switching part 142) for connecting and separating the fuel cell stack to and from the initiation load so as to separate the initiation load from the fuel cell stack (310). If the initiation load is connected to the fuel cell stack when initiating the fuel cell system, this step may be omitted.

Next, the controller periodically measures the temperature of the fuel cell stack so as to separate the external load from the fuel cell stack (312). If the external load is not connected to the fuel cell stack when initiating the fuel cell system, this step may be omitted(312). Then, the controller determines whether or not the measured temperature is within a predetermined range (314).

After the determination, when the measured temperature is within the predetermined range, the controller turns the first switching part off (316) so as to separate the initiation load from the fuel cell stack (318). Moreover, the controller turns the second switching part on to connect the external load to the fuel cell stack (320). Additionally, if the determination of the measured temperature is not within the predetermined range, the controller will again determine whether the measured temperature is within the predetermined range again at a later time. Also, the controller may stop the fuel cell when the measured temperature from the fuel cell stack is at an abnormal temperature (e.g., at an abnormally high temperature).

Due to the above procedures, the fuel cell stack is rapidly and stably initiated, whereby the fuel cell system is rapidly and normally driven (322).

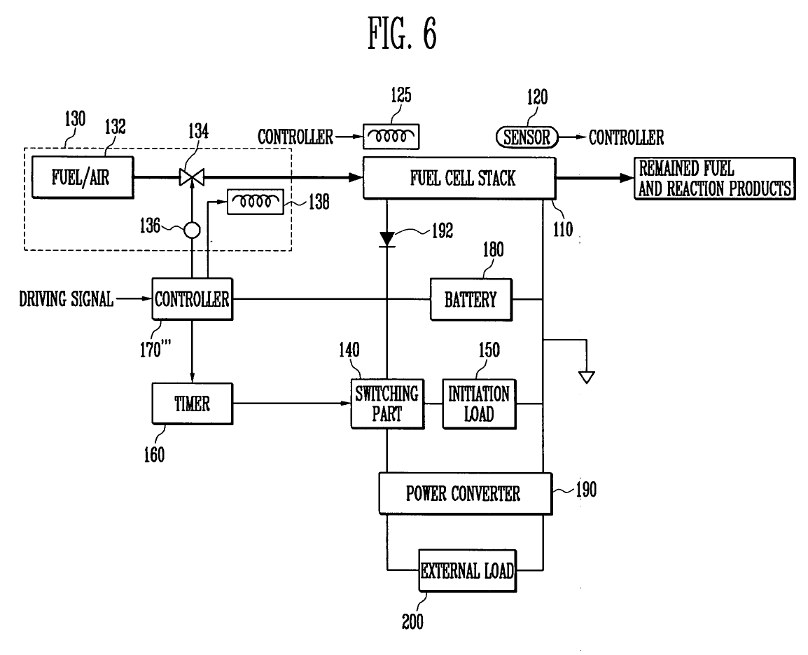

FIG. 5 is a block diagram illustrating a fuel cell system for rapidly initiating a fuel cell stack according to a third embodiment of the present invention.

Referring to FIG. 5, the fuel cell system according to this embodiment of the present invention implements a rapid initiation of a fuel cell stack by rapidly warming up the fuel cell stack for a predetermined period of time using an initiation load and a timer. To this end, the fuel cell system according to the third embodiment of the present invention includes the fuel cell stack 110, the fuel-supplying unit 130, the switching part 140, the initiation load 150, a timer 160, a controller 170″, and the battery 180. The fuel cell is connected to the external load 200 through a power converter such as a DC-DC converter and/or DC-AC converter.

In more detail, the controller 170″ responds to an initial driving signal of the fuel cell system and connects the initiation load 150 to the fuel cell stack 110 according to a predetermined program. The controller 170″ uses the timer 160 connected to the switching part 140 to connect the initiation load 150 to the fuel cell stack 110. In this embodiment, the controller 170″, in contrast to the controller 170 of the first embodiment described above, does not need to compare a stack temperature received from a temperature sensor with a predetermined temperature and to determine a normal output time of the fuel cell. Thus, in this embodiment, the program installed in the controller 170″ is simpler than the controller 170 of the first embodiment.

The timer 160 has a predetermined ON-setting time and is driven by the controller 170″. The timer 160 is structured such that the switching part 140 is switched according to the ON/OFF operation thereof. The timer 160 may be implemented by, for example, widely known 555 timers.

The ON-setting time of the timer 160 is differently set according to the structure or kind of the fuel cell stack 110. For example, the ON-setting time can be set by measuring the warm-up time of the fuel cell stack 110 that is rapidly warmed up by the initiation load when initiating the fuel cell. In this case, in actually used fuel cell systems, the sensor for detecting the temperature of the fuel cell stack 110 may be omitted. In one embodiment as shown below in Table 1, the ON-setting time can be set as a function of an initial temperature of the fuel cell stack 110.

TABLE 1

| Temperature of stack (° C.) | ON-setting time of timer |
|---|---|
| Below −20 | Equal to or greater than 20 minutes |
| −20 to below −10 | 15 minutes |
| −10 to below 0 | 10 minutes |
| 0 to below 10 | 7 minutes |
| 10 to below 20 | 4 minutes |
| 20 to below 30 | 2 minutes |
| Equal to or greater than 30 | Equal to or less than 1 minute |

The switching part 140 is connected between the initiation load 150 and the external load 200 so as to selectively connect or separate one of the initiation load 150 and the external load 200 to or from the fuel cell stack 110. The switching part 140 is connected to the controller through the timer 160.

Moreover, the switching part 140 connects the initiation load 150 to the fuel cell stack 110 (the initiation load 150 serving as a proper load resistor so as to rapidly warm up the fuel cell stack 110) according to the operation of the timer 160 due to the control of the controller 170″ when initiating the fuel cell, and separates the external load 200 from the fuel cell stack 110. The switching part 140 separates the initiation load 150 from the fuel cell stack 110 and connects the external load 200 to the fuel cell stack 110 when the fuel cell stack 110 is stabilized and starts to be normally driven, in other words, when the ON-setting time of the timer 160 is completed. This may be performed according to an OFF operation of the timer 150 regardless of the control of the controller 170″.

Additionally, in the description of the fuel cell stack 110, the fuel-supplying unit 130, the initiation load 150, and the battery 180 will be omitted to avoid duplicate description of those of the above first and second embodiments.

Due to the above-mentioned structure, the fuel cell system of this embodiment can be normally driven in rapid and stable state by setting a predictable normal driving time (or warm up time) due to the initiation load using a timer without a temperature sensor such as thermistor.

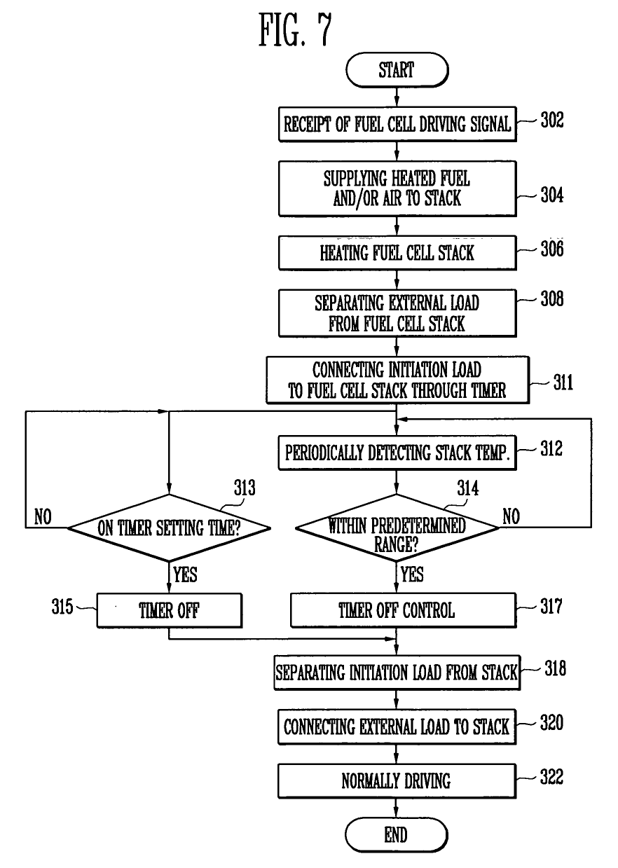

FIG. 6 is a block diagram illustrating a fuel cell system for rapidly initiating a fuel cell stack according to a fourth embodiment of the present invention.

Referring to FIG. 6, the fuel cell system according to this embodiment rapidly and normally drives the fuel cell by rapidly warming up the fuel cell stack using an initiation load together with a temperature sensor and a timer. To this end, the fuel cell system according to the fourth embodiment of the present invention includes the fuel cell stack 110, the sensor 120, the fuel supplying unit 130 the switching part 140, the initiation load 150, the timer 160, a controller 170″′, and the battery 180. The fuel cell system is connected to the external load 200 through the power converter 190 such as a DC-DC converter and/or DC-AC converter.

The fuel cell system of this embodiment is similar to the fuel cell systems of the first, second, and third embodiments. Therefore, hereinafter, duplicate description will be omitted.

As such to normally drive the fuel cell more rapidly and stably than a conventional fuel cell, the fuel cell system of this embodiment uses the initiation load 150 to rapidly warm up the fuel cell stack 110, the controller 170″′ to determine whether the temperature of the fuel cell stack 110 is within a predetermined range by measuring the temperature of the fuel cell stack 110 and to normally drive the fuel cell at a normal driving time of the fuel cell using the determined result, and the timer 160 driven for a predetermined ON-setting time according to characteristics of how rapidly the fuel cell stack 110 is warmed up by the initiation load 150.

Moreover, the fuel cell system includes a first heating device 125 for heating the fuel cell stack 110 based on a driving signal so as to rapidly warm up the fuel cell stack 110 when initiating the fuel cell system, and/or a second heating device 138 for heating fuel and/or oxidant, such as methanol and/or air, supplied to the fuel cell stack 110 based on the driving signal. In this case, the fuel cell stack 110 is heated more rapidly, whereby the fuel cell can be normally driven in more stable and rapid state. The first heating device 125 for heating the fuel cell stack 110 can be implemented by, for example, a heating wire connected to the outside of the fuel cell stack 110 or a passage extended to the inside of the fuel cell stack 110. The heating devices 125, 138 can be used as another initiation load.

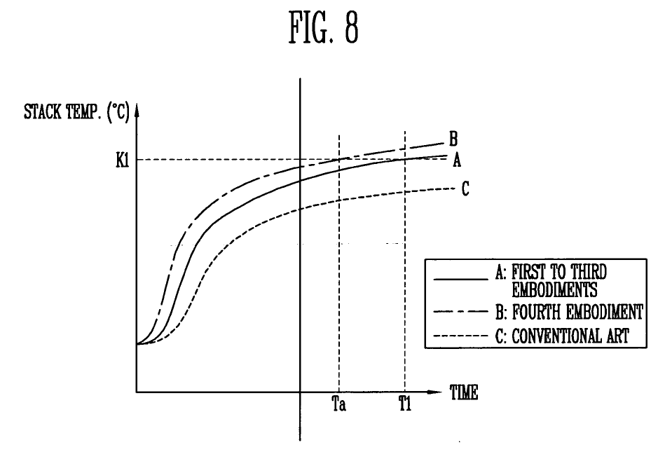

FIG. 7 is a flowchart illustrating a process of rapidly initiating the fuel cell stack of the fuel cell system according to the fourth embodiment of the present invention.

Referring to FIG. 7, a driving signal for driving a fuel cell system is automatically or manually inputted to the fuel cell system (302). Then, a controller receives the driving signal and receives electric power from a battery, and controls the fuel cell system according to a predetermined order such as a program stored in a memory (not shown).

Next, the controller controls a fuel-supplying unit to supply fuel to a fuel cell stack. The controller supplies oxidant and fuel containing hydrogen, such as air and methanol, to the fuel cell stack via respective supplying path using a fuel pump and/or an air pump connected with the fuel tank. In one embodiment, the methanol and/or air are heated by a predetermined heating device and are supplied to the fuel cell stack (304). Moreover, the fuel cell stack is heated by a heating device such as a heating wire (306).

Then, the controller controls a switching part to separate an external load from the fuel cell stack (308). Next, the controller controls the switching part through the timer to connect an initiation load to the fuel cell stack (311). Here, the switching operation for separating the external load from the fuel cell stack and the operation for connecting the initiation load to the fuel cell stack are performed by a single switching operation. If, when initiating the fuel cell, the external load is not connected to the fuel cell stack and/or the initiation load is connected to the fuel cell stack, the respective step (308) and/or the step (311) are omitted.

Next, the controller periodically measures the temperature using a sensor (312). Then, the controller determines whether or not the measured temperature is within the predetermined range (314).

According to the determination, when the measured temperature is within the predetermined range, the timer is turned off (317). Simultaneously with the OFF-operation of the timer, the switching part is switched, whereby the initiation load is separated from the fuel cell stack (318). Next when, simultaneously with the OFF-operation of the timer, the switching part is switched, the external load is connected to the fuel cell stack (320).

Moreover, according to the determination, if the measured temperature is not within the predetermined range, the controller will again determine whether the temperature measured from the fuel cell stack is within the predetermined range at a later time.

Also, after connecting the initiation load to the fuel cell stack through the timer, the controller determines whether or not the ON-setting time of the timer has lapsed (313). Here, the ON-setting time is determined according to characteristics of how rapidly the fuel cell stack is warmed up by the initiation load. When the ON-setting time of the timer has lapsed, the timer is turned off (315). When the timer is turned off, the switching part connected to the timer is automatically restored to the former state. At this time, the controller may withhold the restoration of the switching part due to the OFF-operation of the timer and may control the switching part until the temperature of the fuel cell stack reaches the predetermined range according to a predetermined installed program or priority. In this case, the degrees of freedom of control of the fuel cell are improved (e.g., can be controlled by the timer alone, by the sensor alone, or by the timer and the sensor).

After that, the initiation load is separated from the fuel cell stack, and the external load is connected to the fuel cell stack so that the fuel cell is normally driven (318, 320, and 322).

According to the above-mentioned procedures, the fuel cell stack is initiated more rapidly and stably, whereby the fuel cell is normally driven more rapidly.

FIG. 8 is a graph illustrating comparisons of initiations of the fuel cell stacks according to the first to fourth embodiments of the present invention with an initiation of a conventional fuel cell stack.

As shown in FIG. 8, the fuel cell embodiments according to the present invention are driven more rapidly than the conventional fuel cell. In the case of fuel cells according to the first, second, and third embodiments, for a predetermined period of time T1 after initiating the fuel cell, the temperature of the fuel cell stack has reached the temperature K1 for stably driving the fuel cell stack. In the fuel cell (B) according to the fourth embodiment of the present invention, for a predetermined period of time Ta after initiation, the temperature of the fuel cell stack has reached the predetermined temperature K1 for stably driving the fuel cell stack. However, in the conventional fuel cell (C), for the predetermined period of time T1 after the initiation, the temperature of the fuel cell stack still has not reached the predetermined temperature K1 for stably driving the fuel cell stack and has only reached the predetermined temperature K1 after the predetermined period of time T1.

As such, it can be understood that the fuel cell system embodiments according to the present invention can warm up their respective fuel cell stacks when initiating the fuel cells more rapidly than the conventional fuel cell system.

Also, the fuel cell system according to the certain embodiments is manufactured in the form of a polymer electrolyte type fuel cell or a direct-methanol type fuel cell proper to make the fuel cell small in size.

As described above, a fuel cell system of an embodiment of the present invention can rapidly and normally initiate a fuel cell stack by coupling a peripheral device and/or a separated initiation load with an output terminal of the fuel cell stack. Moreover, a fuel cell system of an embodiment can normally drive a fuel cell stack in rapid and stable state by measuring the temperature of the fuel cell stack warmed up by an inner initiation load and controlling a normal driving time of the fuel cell stack. Additionally, a fuel cell system of an embodiment can normally drive a fuel cell stack in a convenient and rapid state by setting a preheat time of the fuel cell stack preheated by an initiation load using a timer. Moreover, a fuel cell system of an embodiment can normally drive a fuel cell stack more rapidly and stably than a conventional fuel cell system, even when the initial temperature of the fuel cell stack is lowered under a low or cold temperature circumstance that is lower than a room temperature by properly changing a timer setting time according to the present temperature of the fuel cell stack.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A fuel cell system comprising:
a fuel cell stack including at least one unit fuel cell for generating electricity through an electro-chemical reaction of an oxidant and a fuel containing hydrogen;
a fuel-supplying unit for supplying the fuel and the oxidant to the fuel cell stack;
a sensor for detecting a temperature of the fuel cell stack;
an initiation load having a predetermined resistance; and
a switching part for electrically connecting the initiation load to an output terminal of the fuel cell stack.

2. The fuel cell system as claimed in claim 1, wherein the initiation load comprises a load of a peripheral device included in the fuel-supplying unit.

3. The fuel cell system as claimed in claim 1, wherein the initiation load comprises a rod resistor for emitting an electric power applied through the output terminal of the fuel cell stack as heat.

4. The fuel cell system as claimed in claim 1, further comprising a controller for controlling a supply of the fuel and the oxidant depending on a predetermined driving signal and for controlling the switching part such that the initiation load is connected to the fuel cell stack.

5. The fuel cell system as claimed in claim 4, wherein the controller electrically separates the initiation load from the fuel cell stack through the switching part when the temperature detected by the sensor is within a predetermined range.

6. The fuel cell system as claimed in claim 5, wherein the controller electrically separates an external load from the fuel cell stack depending on the driving signal and electrically connects the external load to the fuel cell stack when the temperature detected by the sensor is within the predetermined range.

7. The fuel cell system as claimed in claim 6, wherein the switching part comprises:
a first switching part connected between the fuel cell stack and the initiation load; and
a second switching part connected between the fuel cell stack and the external load.

8. The fuel cell system as claimed in claim 1, wherein the switching part responds to a stop signal of the fuel cell system to reconnect the initiation load with the fuel cell stack.

9. The fuel cell system as claimed in claim 1, further comprising a battery for supplying an electric power to a controller of the switching part, and a pump or a valve in the fuel-supplying unit.

10. The fuel cell system as claimed in claim 1, wherein the fuel-supplying unit comprises a heating device for heating at least one of the fuel or the oxidant according to a driving signal.

11. The fuel cell system as claimed in claim 1, further comprising a heating device for heating the fuel cell stack according to a driving signal.

12. The fuel cell system as claimed in claim 1, further comprising a power converter for converting and transmitting an output voltage of the fuel cell stack to the external load.

13. The fuel cell system as claimed in claim 1, wherein the fuel cell system is a polymer electrolyte type fuel cell system.

14. The fuel cell system as claimed in claim 1, wherein the fuel cell system is a direct-methanol type fuel cell system.

15. A fuel cell system comprising:
a fuel cell stack including at least one unit fuel cell for generating electricity through an electro-chemical reaction of an oxidant and a fuel containing hydrogen;
a fuel-supplying unit for supplying the fuel and the oxidant to the fuel cell stack;
an initiation load having a predetermined resistance;
a switching part for connecting the initiation load to an output terminal of the fuel cell stack; and
a timer connected to a control terminal of the switching part to control the switching part using an ON-setting time.

16. The fuel cell system as claimed in claim 15, further comprising a controller for controlling the supply of the fuel and the oxidant depending on a driving signal for driving the fuel cell stack and for turning on the timer.

17. The fuel cell system as claimed in claim 16, further comprising a sensor for detecting a temperature of the fuel cell stack,
wherein the controller controls the timer to electrically separate the initiation load from the fuel cell stack through the switching part when the temperature inputted from the sensor is within a predetermined range.

18. The fuel cell system as claimed in claim 16, wherein the controller extends the ON-setting time of the timer as long as the temperature inputted from the sensor is not within the predetermined range.

19. The fuel cell system as claimed in claim 15, wherein the switching part is turned off such that the initiation load is electrically separated from the fuel cell stack after the ON-setting time of the timer has lapsed.

20. The fuel cell system as claimed in claim 15, wherein the switching part responds to a stop signal of the fuel cell system to reconnect the initiation load to the fuel cell stack.
